(19) United States
(12) Patent Application Publication
(10) Pub. No.: US 2021/0012664 A1
(43) Pub. Date: Jan. 14, 2021

(54) METAMATERIAL-BASED ADVANCED DETECTION AND WARNING SYSTEM

(71) Applicants: Luke Satterlee, Washington, IL (US); Phillip Trompeter, Germantown Hills, IL (US)

(72) Inventors: Luke Satterlee, Washington, IL (US); Phillip Trompeter, Germantown Hills, IL (US)

(73) Assignee: Landslide Group, LLC, Washington, IL (US)

(21) Appl. No.: 16/911,281

(22) Filed: Jun. 24, 2020

Related U.S. Application Data
(60) Provisional application No. 62/866,447, filed on Jun. 25, 2019.

(51) Int. Cl. G08G 1/16

(52) U.S. Cl. CPC G08G 1/167

(57) ABSTRACT

Embodiments of the present invention provide a vehicle-mountable advanced detection and warning system comprising at least one warning response and a wave transmitter having an emitter, a wave detector, and a metamaterial lens configured to bend and focus electromagnetic waves. The metamaterial lens focuses transmitted detection waves produced by the emitter in a specific range and frequency defined by a user. The transmitter forms a detection area. Once an object is detected within the detection area, the transmitter engages a warning indicator to alert the user of the object. A plurality of transmitters may also be attached to a vehicle and configured with variable detection ranges to form a proximity detection area surrounding the vehicle.

### CROSS-REFERENCE TO RELATED APPLICATIONS

This application claims the benefit of U.S. Provisional Patent Application No. 62/866,447, filed Jun. 25, 2019.

### BRIEF DESCRIPTION OF THE INVENTION

Embodiments of the present invention provide a vehicle-mountable advanced detection and warning system comprising a wave transmitter having a metamaterial lens configured to bend and focus electromagnetic waves. In some embodiments of the invention, the metamaterial lens is further configured to focus transmitted detection waves.

In some embodiments of the invention, the metamaterial lens comprises a plano-concave shape configured to bend electromagnetic waves through a process involving negative refraction. The metamaterial lens is further configured to focus microwaves and radio waves at a specific angle and at a specific frequency.

The transmitter of the warning system may further comprise an emitter and configured to couple a rear end of a vehicle. The emitter may be configured to emit radar waves or microwaves. The transmitter further comprises a wave detector configured to receive reflected waves originating from the emitter and reflected by at least one object located within a detection area of the transmitter.

The transmitter is configured to detect a velocity of the at least one object within the detection area of the transmitter. In additional embodiments of the invention, the transmitter is further configured to detect a direction of travel of the at least one object within the detection area of the transmitter. In other embodiments, the transmitter of the invention is configured to function both while the vehicle is stationary and while the vehicle is in motion. The detection area of the transmitter may be configured by a user to comprise a plurality of lanes of travel located at the rear of the vehicle and may include partial portions of a given lane of travel. The area of detection may also be configured by a user to comprise less than one lane of travel.

In additional embodiments of the invention, the transmitter is in connection with at least one warning response and configured to engage the at least one warning response after detecting at least one object within the detection area of the transmitter. The transmitter may be further configured to engage a warning response after detecting at least one parameter of the at least one object within the detection area of the transmitter, the at least one parameter having a value within a pre-set range.

In some embodiments, the transmitter is further configured in connection with a steering-wheel-mounted horn of the vehicle. In other embodiments, the transmitter is in connection with at least one additional warning response coupled to the vehicle. In other embodiments, a video recording device configured for low-light use is affixed to the vehicle and in connection with the transmitter. The video recording device is further configured to initiate video capture in response to a signal from the transmitter detecting an object within the detection area of the transmitter.

In some embodiments of the invention, the at least one warning response or the at least one additional warning response may comprise a plurality of warning lights configured to alert a user within an immediate vicinity of the vehicle, as well as to alert and deter the object within the detection area of the transmitter.

In another embodiment, the invention may further comprise at least one additional transmitter coupled to the vehicle, the transmitter having metamaterial lens and emitter. The at least one additional transmitter may further comprise a detection area of variable distance and direction. In some embodiments, a plurality of additional transmitters may be coupled to a vehicle and configured with a plurality of detection areas such that the plurality of transmitters can detect objects within an immediate proximity around the vehicle.

In another embodiment, the metamaterial lens of the transmitter may be coupled to at least one existing proximity detection sensor coupled to the vehicle. The metamaterial lens may be further configured to bend and focus waves emitted by the proximity detection sensors, such that a detection area formed comprises a conical shape, and may intersect with other detection areas of other proximity detection sensors having metamaterial lenses to form an overall detection area surrounding the vehicle.

In some embodiments, the plurality of transmitters coupled to the vehicle may be configured to triangulate positions of an object within the detection area of the plurality of transmitters and may further be in connection with an indicator located within the vehicle. The indicator is configured to present the triangulated position of at least on object within the area of detection of the plurality of transmitters. Further, the plurality of transmitters may also be in connection with the warning response or at least one additional warning response, such that detection of an object within the detection area will initiate the warning response and/or at least one additional warning response.

The methods, systems, and apparatuses are set forth in part in the description which follows, and in part will be obvious from the description, or can be learned by practice of the methods, apparatuses, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed. More details concerning these embodiments, and others, are further described in the following figures and detailed description set forth herein below.

### BRIEF DESCRIPTION OF THE DRAWINGS

FIG. 1 illustrates a perspective view of the warning system.

FIG. 2 illustrates a perspective view of the warning system.

### DETAILED DESCRIPTION OF THE INVENTION

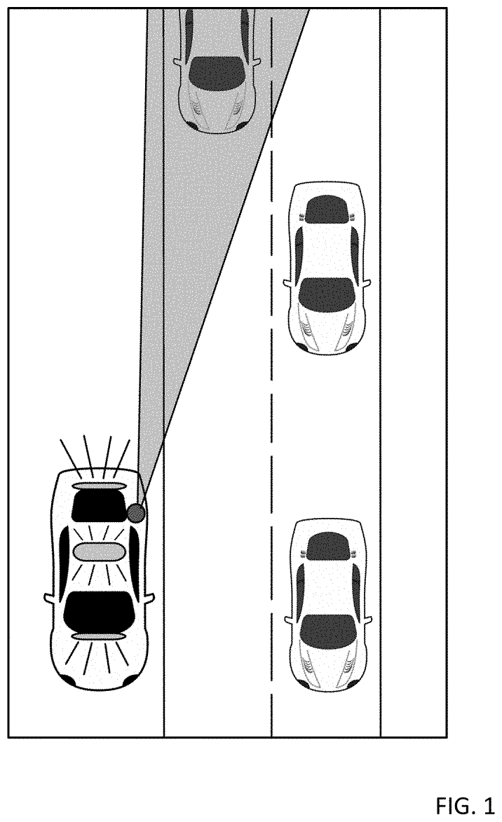

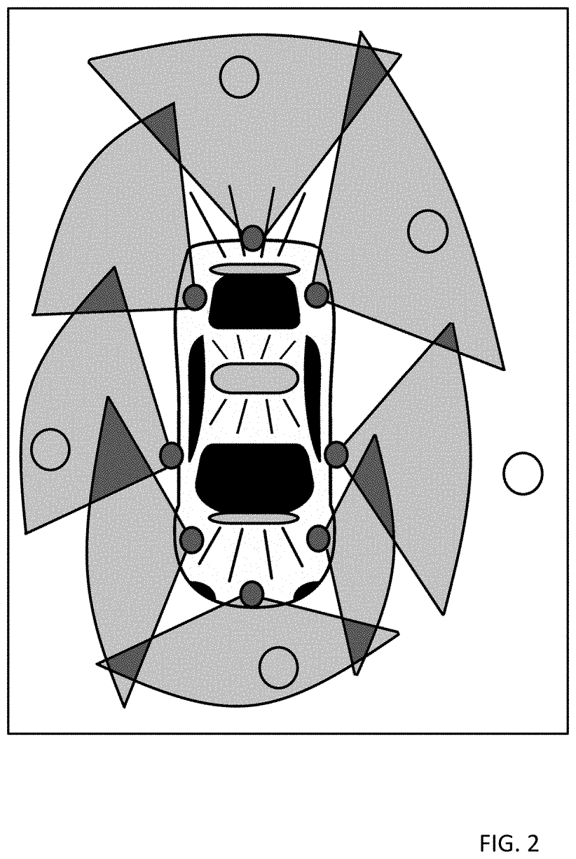

FIGS. 1 and 2 present a vehicle-mountable advanced detection and warning system comprising at least one warning response and a wave transmitter having an emitter, a wave detector, and a metamaterial lens configured to bend and focus electromagnetic waves. The metamaterial lens is further configured to focus transmitted detection waves produced by the emitter in a range specified by a user.

The metamaterial lens may comprise a plurality of structures, configured to interact with electromagnetic waves to bend or focus them. The metamaterial lens may comprise at least one material, and may comprise a plurality of differing materials. Materials used in forming the metamaterial lens include, but are not limited to, metals, plastics, polymers, and glass. In some embodiments of the invention, the metamaterial lens comprises an overall plano-concave shape, being configured to bend electromagnetic waves through a process involving negative refraction. Specifically, the metamaterial lens is configured to bend and focus radio waves and microwaves. Additionally, the metamaterial lens may be configured to focus microwaves and radio waves at a specific angle and at a specific frequency, defined by a user.

The transmitter of the warning system may further comprise an emitter configured to couple a rear section of a vehicle. The emitter may be configured to emit radio waves or microwaves. In other embodiments, the emitter may be configurable to emit specific types of waves as well as specific frequencies and specific angles. The transmitter further comprises a wave detector configured to receive reflected waves originating from the emitter and reflected by at least one object located within a detection area of the transmitter.

The transmitter is further configured to detect a velocity of an object located within the detection area of the transmitter. In additional embodiments of the invention, the transmitter is further configured to detect a direction of travel of an object located within the detection area of the transmitter. The transmitter of the invention may further be configured to function both while the vehicle is stationary and while the vehicle is in motion.

The detection area of the transmitter may further be configured by a user to comprise and cover a plurality of lanes of travel located at the rear of the vehicle and may include partial portions of a given lane of travel. The detection area of the transmitter may also be configured by a user to comprise less than one lane of travel. Additionally, the angle of the transmitter may be adjusted by a user to allow a detection area covering a conical area, spanning multiple lanes as well as portions of a single lane of travel.

The transmitter is further coupled in connection with at least one warning response and configured to engage the at least one warning response after detecting an object within the detection area of the transmitter. The transmitter may be further configured to engage a warning response after detecting at least one parameter of an object within the detection area of the transmitter, the at least one parameter having a value within a pre-set range. The at least one parameter may include, but is not limited to, velocity of an object, position of an object, acceleration of an object, or direction of travel of an object.

The transmitter may further be coupled in connection with a steering-wheel-mounted horn of the vehicle, configured to engage the horn of the vehicle upon detection of an object within the detection area of the transmitter. In other embodiments, the transmitter is in connection with at least one additional warning response coupled to the vehicle. The at least on additional warning response includes but is not limited to high-visibility lights mounted to the vehicle, external alarms of the vehicle, or a wireless haptic indicator coupled to or held by the user. In other embodiments of the invention, the at least one warning response or the at least one additional warning response may further comprise a plurality of warning lights configured to alert a user within an immediate vicinity of the vehicle, as well as to alert and deter the object within the detection area of the transmitter. The warning response and/or at least one additional warning response may be configured in connection with an external warning indicator, the external warning indicator configured to alert a remote user or system.

A video recording device configured for low-light use may be affixed to the vehicle and in connection with the transmitter. The video recording device is further configured to initiate video capture in response to a signal from the transmitter detecting an object within the detection area of the transmitter.

The warning system may further comprise at least one additional transmitter coupled to the vehicle, the transmitter having metamaterial lens and emitter. The at least one additional transmitter may further comprise a detection area of variable distance and direction.

A plurality of additional transmitters may be coupled to a vehicle and configured with a plurality of detection areas such that the plurality of transmitters can detect objects within an immediate proximity and forming a proximity detection area encompassing the vehicle and area surrounding the vehicle.

In another embodiment, the metamaterial lens of the transmitter may be coupled to at least one existing proximity detection sensor coupled to a vehicle. The metamaterial lens may be further configured to bend and focus waves emitted by the proximity detection sensors, such that a detection area formed comprises a conical shape, and may intersect with other detection areas of additional proximity detection sensors having metamaterial lenses to form an overall detection area surrounding the vehicle.

In some embodiments, the plurality of transmitters coupled to the vehicle may be configured to triangulate at least one position of an object within the detection area of the plurality of transmitters and may further be in connection with an indicator located within the vehicle.

The indicator is configured to present the triangulated position of at least on object within the area of detection of the plurality of transmitters. Further, the plurality of transmitters may also be in connection with the warning response or at least one additional warning response, such that detection of an object within the detection area will initiate the warning response and/or at least one additional warning response.

While particular elements, embodiments, and applications of the present invention have been shown and described, the invention is not limited thereto because modifications may be made by those skilled in the art, particularly in light of the foregoing teaching. It is therefore contemplated by the application to cover such modifications and incorporate those features which come within the spirit and scope of the invention.

What is claimed is:

1. A vehicle-mountable advanced detection and warning system comprising:
a. a transmitter having an emitter, a wave detector, and a metamaterial lens;
b. at least one warning response in connection with the transmitter;
c. wherein the emitter is configured to emit radio waves or microwaves.
d. wherein the wave detector is configured to receive reflected waves originating from the emitter.
e. wherein the metamaterial lens is configured to bend and focus transmitted detection waves produced by the emitter; and
f. wherein the emitter, wave detector, and metamaterial lens of the transmitter form a detection area of the transmitter.

2. The warning system of claim 1, wherein the metamaterial lens comprises an overall plano-concave shape.

3. The warning system of claim 2, wherein the metamaterial lens is configured to focus electromagnetic waves at a specific frequency and a specific angle, the frequency and the angle being defined by a user.

4. The warning system of claim 3, wherein the transmitter is configured to detect a velocity of an object located within the detection area of the transmitter.

5. The warning system of claim 4, wherein the transmitter is configured to detect a position of an object located within the detection area of the transmitter.

6. The warning system of claim 5, wherein the detection area comprises a conical area, spanning multiple lanes of travel.

7. The warning system of claim 6, wherein the detection area comprises a conical area, capable of spanning portions of at least one lane of travel.

8. The warning system of claim 7, wherein the transmitter is configured to engage the warning response after detecting an object within the detection area of the transmitter.

9. The warning system of claim 8, wherein the transmitter is configured to engage the warning response after detecting at least one parameter of an object within the detection area of the transmitter.

10. The warning system of claim 9, further comprising at least one additional warning response in connection with the transmitter.

11. The warning system of claim 5, comprising a plurality of transmitters in mutual connection and comprising a detection area of variable distance and direction to form a detection area surrounding a vehicle.

12. The warning system of claim 1, wherein the metamaterial lens of the transmitter may be coupled to at least one existing proximity detection sensor coupled to a vehicle.

13. The warning system of claim 12, wherein the metamaterial lens is configured to bend and focus waves emitted by the existing proximity detection sensors, forming a detection area having a conical shape that may intersect with other detection areas of at least one other existing proximity detection sensors having a metamaterial lens coupled thereto, forming an overall detection area.
